(19) United States
(12) Patent Application Publication
(10) Pub. No.: US 2006/0001523 A1
(43) Pub. Date: Jan. 5, 2006

(54) Keyless remote vehicle dealership vehicle control system employing a wireless telephone vehicle management system

(76) Inventors: Craig T. Underdahl, Winona, MN (US); Bryan W. Bockhop, Snellville, GA (US)

Correspondence Address: BRYAN W. BOCKHOP, ESQ., 2375 MOSSY BRANCH DR., SNELLVILLE, GA, 30078, US

(21) Appl. No.: 11/191,474

(22) Filed: Jul. 28, 2005

Related U.S. Application Data
(63) Continuation-in-part of application No. 11/150,992, filed on Jun. 13, 2005.
(63) Continuation-in-part of application No. 11/125,761, filed on May 10, 2005.
Application No. 11/125,761 is a division of application No. 10/105,209, filed on Mar. 25, 2002, now Pat. No. 6,937,138.

(51) Int. Cl. G05B 19/00

(52) U.S. Cl. 340/5.64; 340/5.5; 307/10.5; 701/49

(57) ABSTRACT

In a system, used by an automobile dealership having a sales lot, for managing operating parameters of a plurality of vehicles that are responsive to a wireless telephone system-based vehicle management system, a station is responsive to a wireless communications device used by a salesperson. The station includes a receiver and a computer. The computer programmed to receive a communication from the wireless communications device indicating that the salesperson desires to change an operating parameter of a selected vehicle on the sales lot to a desired operating state and send a communication instructing the wireless telephone system-based vehicle management system to send a signal via a wireless telephone system to the selected vehicle that will place the selected vehicle in the desired operating state.

### CROSS-REFERENCE TO RELATED APPLICATIONS

This application is a continuation-in-part of, and claims the benefit of, U.S. patent application Ser. No. 11/150,992, filed on Jun. 13, 2005, and U.S. patent application Ser. No. 11/125,761, filed May 10, 2005, which is a divisional of U.S. patent application Ser. No. 10/105,209, filed Mar. 25, 2002, the entirety of which is hereby incorporated herein by reference.

### BACKGROUND OF THE INVENTION

1. Field of the Invention

The present invention relates to vehicle control systems and, more specifically, to a system that allows a vehicle dealership to control the state of a plurality of vehicles.

2. Description of the Prior Art

Automobile dealerships and other transportation related organizations, for example, must maintain a constant effort to prevent the theft of vehicles. Additionally, dealerships have a problem keeping up with the keys to the vehicles and supplying them for the respective vehicles when needed. Typically, the keys to a vehicle are kept in a common location of a dealership showroom or are kept at the vehicle in a local lockbox that is attached to the vehicle. There are several advantages to having the keys at the vehicle in terms of convenience for both the dealership staff and the customer. For example, a dealership is likely to make more sales if the keys can be kept at the vehicle, as prospective customers have less time to reconsider their buying decisions. Also, storing a plurality of keys in a common location to which several different people have regular access increases the likelihood that the keys will become disorganized.

The local lockbox approach also has several disadvantages. For example, a car thief can spray a refrigerant into the lock of the lockbox to make it brittle and then shatter the lock by striking it with a hammer. Also, if the keys necessary to open the local lockboxes are lost or stolen, then the security of the vehicles is compromised. Thus, if a dealership employee leaves the employ of the dealership without returning his lockbox keys, then every lock must be replaced at a considerable cost to the dealership. Furthermore, a local lockbox attached to a vehicle makes the vehicle look less attractive to the buyer, and may even damage the finish of the vehicle.

Some dealerships unlock all of the vehicles on the lot in the morning and then relock the vehicles at night. This allows potential buyers to examine the insides of the vehicles at will during normal business hours. However, unlocking every vehicle is a labor-intensive process that ties up a considerable amount of dealership staff time.

Many modern vehicles are equipped with remote door lock controls. The user is supplied with a remote transmitter that allows for locking and unlocking of vehicles at the press of a button. However, the use of existing remote devices does not overcome the difficulties experienced with dealerships because each remote transmitter must be tuned to respond to a unique code to prevent unauthorized access to the vehicles. Thus, the dealership staff must spend unnecessary overhead in organizing the remote transmitters.

Many modern vehicles are also equipped with circuitry that is responsive to remote vehicle management systems, such as On-Star®, which uses factory installed circuitry in communication with a wireless telephone system, and MILLENIUM PLUS GPS, available from Horizon Technologies, LLC, which uses an add-on device, in communication with a satellite, that is installable in a vehicle's control system. Such systems allow users to control remotely operating parameters of vehicles. Such operating parameters include the locking state of the doors of the vehicle (i.e., whether the vehicle is locked or unlocked) and the operation enable state of the vehicle (i.e., whether the vehicle can be started or not). Such systems do not, by themselves, allow a vehicle dealer to unlock or lock a plurality of vehicles at a sales lot simultaneously (or substantially simultaneously), nor do they allow a vehicle dealer to enable or disable a plurality of vehicles at a sales lot simultaneously (or substantially simultaneously). Also, such systems do not allow the dealer to cause all of a group of vehicles to be locked or unlocked (or enabled or disabled) upon occurrence of a predefined event, such as a predetermined time.

Therefore, there is a need for a device that allows simultaneous remote locking and unlocking of a plurality of vehicles using a satellite-based vehicle system.

There is also a need for a device that allows simultaneous remote enabling and disabling of a plurality of vehicles using a satellite-based vehicle system

### SUMMARY OF THE INVENTION

The disadvantages of the prior art are overcome by the present invention which, in one aspect, is a station, used by an automobile dealership having a sales lot, for managing operating parameters of a plurality of vehicles that are responsive to a wireless telephone-based vehicle management system. The station is responsive to a wireless communications device used by a salesperson. The station includes a receiver and a computer. The receiver receives transmissions from the wireless communications device. The computer is in communication with the receiver and is in communication with a communications network. The computer programmed to execute the following instructions: receive a communication from the wireless communications device indicating that the salesperson desires to change an operating parameter of a selected vehicle on the sales lot to a desired operating state; examine a database to retrieve a predetermined code corresponding to the selected vehicle; and send a communication via the communications network to the wireless telephone-based vehicle management system, the communication instructing the wireless telephone-based vehicle management system to send a signal via a wireless telephone system to the selected vehicle that will place the selected vehicle in the desired operating state.

In another aspect, the invention is a device for use in a vehicle dealership having a sales lot upon which are placed a plurality of vehicles wherein each of the plurality of vehicles is responsive to a wireless telephone-based vehicle management system for controlling operating parameters of the plurality of vehicles. The device includes a computer in communication with a communications network that is programmed to execute the following steps: associate a set of the plurality of vehicles with a predetermined event and a predefined operating parameter that the set of the plurality of vehicles is to be placed in upon occurrence of the predetermined event; monitor a parameter to determine when the event occurs; and upon detection of the occurrence of the predetermined event, send an instruction to the wireless telephone-based vehicle management system to cause each of the set of the plurality of vehicles to be placed in the predefined operating parameter.

In another aspect, the invention is a method that is programmed onto a digital computer that is in communication with a communications network, for managing a plurality of vehicles on a vehicle sales lot, wherein each of the vehicles is responsive to a wireless telephone-based vehicle management system. The method initiates a communication with the wireless telephone-based vehicle management system and instructs the wireless telephone-based vehicle management system to change an operating parameter of a set of the plurality of vehicles on the sales lot.

In yet another aspect, the invention is a method for managing a plurality of vehicles on a vehicle sales lot. Each of the plurality of vehicles includes circuitry such that at least one operating parameter of the vehicle is controllable by a wireless telephone-based vehicle management system. In the method, a communication is initiated with a wireless telephone-based vehicle management system. A selected code is input to the wireless telephone-based vehicle management system that instructs the wireless telephone-based vehicle management system to change the operating parameter of each of the plurality of vehicles.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a schematic drawing of an illustrative embodiment of the invention, as applied to a single vehicle.

FIG. 2 is a schematic drawing of an illustrative embodiment of the invention, as applied to a plurality of vehicles.

FIG. 3 is a block diagram of an embodiment of the invention that is applied to the ignition and door lock control systems of a vehicle.

FIG. 4 is a block diagram of an embodiment of the invention that is applied to a dedicated port of a computer used to control certain features of a vehicle.

FIG. 5 is a schematic diagram showing an illustrative embodiment of the invention using a satellite-based vehicle management system.

FIG. 6 is a schematic diagram showing a second illustrative embodiment of the invention using a satellite-based vehicle management system.

FIG. 7 is a schematic diagram showing a third illustrative embodiment of the invention using a satellite-based vehicle management system.

FIG. 8 is a flow chart demonstrating a method according to one illustrative embodiment of the invention.

FIG. 9A is a schematic diagram of a vehicle with a wireless telephone system-based vehicle management system installed thereon.

FIG. 9B is a schematic diagram an illustrative embodiment of the invention employing a wireless telephone system-based vehicle management system.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Also, as used herein, “global computer network” includes the Internet. “Substantially simultaneously” means that a series of events occur within a period of time that is relatively short compared to the amount of time that would have passed to achieve the same result if each of the series events had been effected without the aid of a system of the type disclosed herein.

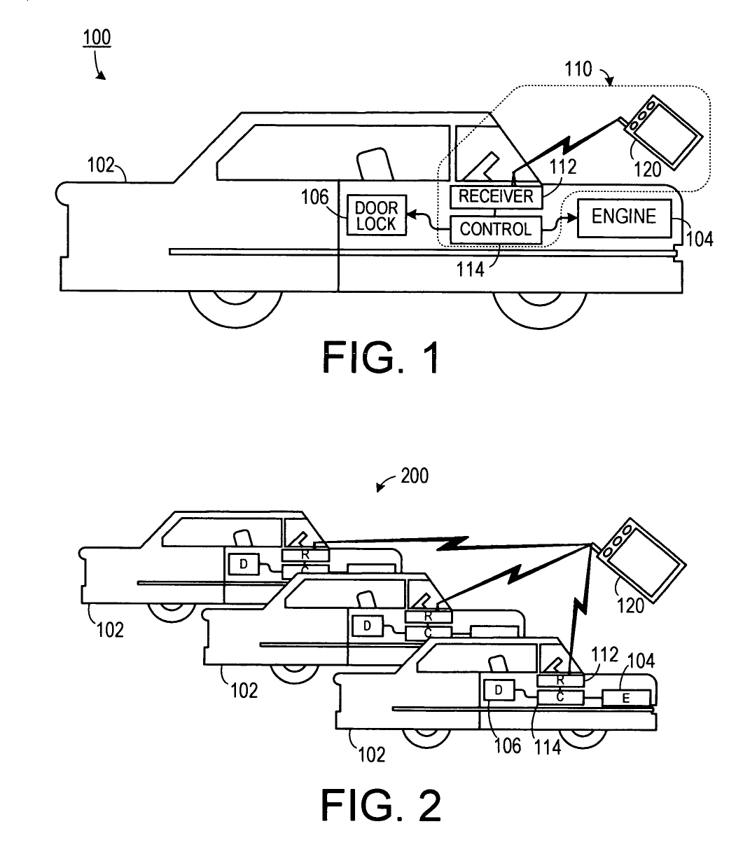

As shown in FIG. 1, one embodiment of the invention 100 is a vehicle 102 that includes an engine 104 and an automatic door locking system 106. A removable door lock control apparatus 110 allows a salesperson at a dealership to control the door lock status. The removable door lock control apparatus 110 includes a signal sensor 112 and a control unit 114 that is responsive to the signal sensor 112. The signal sensor 112 is capable of receiving signals from a transmitter 120. The control unit 114 is capable of controlling the door locking system 106 so that when the signal sensor receives a predetermined signal (such as a specific code) from the transmitter 120, the control unit 114 causes the door locking system 106 to change the door lock state of at least one door of the vehicle 102. For example, if the door lock state for all doors of the vehicle is “locked,” then the salesperson could activate the transmitter 120, thereby causing the door to become “unlocked.” The control unit 114 may also be coupled to the engine 104 of the vehicle 102, so that upon changing the door lock state to “locked,” the engine will be disabled, thereby providing a theft deterrent. As shown in FIG. 2, the door locks 106 of each vehicle 102 of a plurality of vehicles 200, such as at an automobile dealership, may be controlled by a single transmitter 120.

Typically, the keys for a vehicle 102 are locked in the vehicle 102, such a in the glove compartment, on the sales lot. When a customer wishes to take a test drive, the salesperson activates a transmitter 120, thereby unlocking at least one door of the vehicle 102 and the keys are retrieved from the glove compartment. Once the test drive is completed, the keys are returned to the glove compartment and the salesperson relocks the vehicle 102 by actuating the transmitter 120.

Several different types of receiver 112 may be employed. For example, the receiver 112 could be an infra-red sensor. An infra-red system has the advantages of low cost and high selectability. Thus, if a salesperson desires to open only one vehicle, the salesperson could apply the transmitter 120 to the window of the desired vehicle and only that vehicle would become unlocked. Another type of system that has high selectability is a capacitive coupling communication device. Several devices, in which the receiver 112 extends outside the vehicle 102 may be used. These include: a physical plug to which the salesperson attaches the transmitter 120; a magnetic strip reader that allows access when a salesperson applies a card with a magnetic strip (the card being the transmitter); a bar code reader (in which case a bar coded card is used as the transmitter); and even a biometric sensor, such as a finger print scanner. If the transmitter 120 emits a code that uniquely identifies the salesperson to which the transmitter 120 is assigned, then the system may keep an audit trail of each entry into the car by each salesperson, which may be useful in assessing employee habits. Generally, for broadcast-type receivers (e.g., infra-red, radio frequency, etc.) the power level of the transmitter 120 should be low enough to require the transmitter 120 to be in close proximity to the vehicle 102 so that only one vehicle at a time will be responsive to the signal from the transmitter 120.

If the dealership wishes to be able to lock and unlock all of the vehicles simultaneously, then the receiver 112 could be a radio-frequency sensor. In such a case, the transmitter 120 could be a local radio-frequency transmitter, or could even be part of a satellite-based system (which could, for example, be activated by accessing a global computer network site).

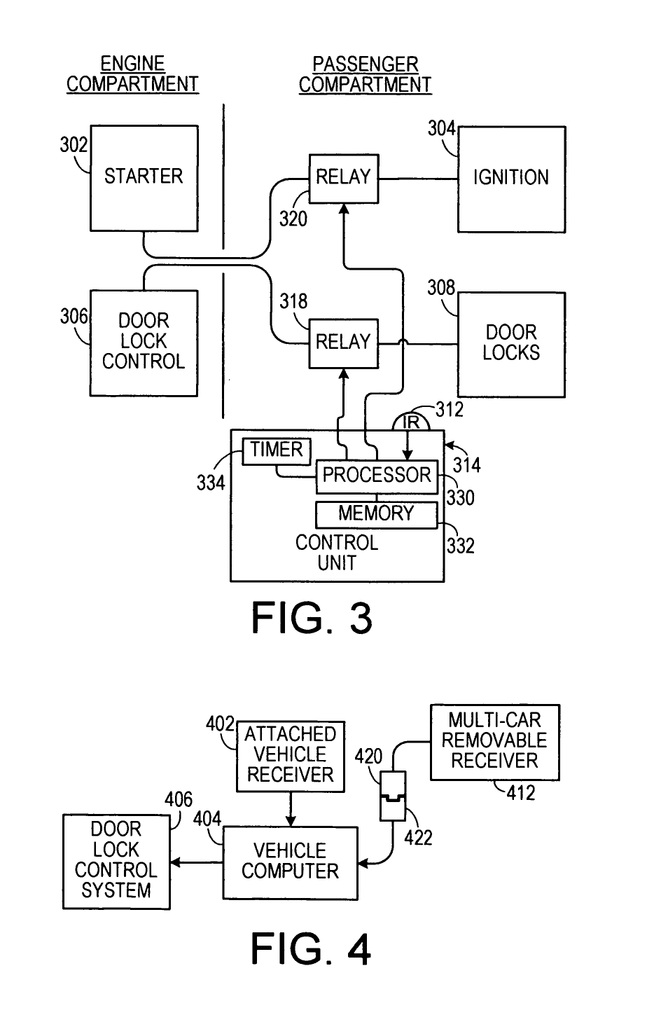

As shown in FIG. 3, the control unit 314 may be coupled to the door locking control system of the vehicle by placing a first controllable switch 318, such as a relay, between the vehicle's installed door lock control unit 306 and the door lock actuator 308 inside the door panel of the vehicle. The first controllable switch 318, which is controlled by the control unit 314, may be controlled to apply power to the door lock actuator 308 to cause a change in state of the door lock. A second controllable switch 320 may be placed between the ignition 304 and the starter 302 to disable the starter 302. The control unit 314 keeps track of the locked state of the door lock and disables the starter 302 whenever the door lock is in the locked state. The control unit 314 could include a processor 330 such as a dedicated microprocessor, a programmable logic controller or any one of the many other types of programmable controllers that are generally known in the art of electronic control circuit design.

When a salesperson leaves the dealership, the codes to which the control unit 314 responds must be changed. This may be done by inputting a supervisor code to the signal sensor 312, or through a separate dedicated data entry port (which could be a hard wired port connected to the control unit 314). The supervisor code is compared to the data in a first memory location in the processor memory 332 and, if they match, then the user is able to input a new code into a second memory location in the processor memory 332. The code in the second memory location is the code to which the control unit will respond for changing the door lock states. The supervisor code and the new code could also be input through a separate receiver, such as a radio-frequency receiver, with the new code being input to a plurality of vehicles simultaneously.

Occasionally, the salesperson will forget to relock a door after taking a customer on a test drive. Therefore, the control unit 314 may be programmed to include a timer 334 that counts a predetermined amount of time from the last time that the door was unlocked. After the expiration of the predetermined time, if the vehicle has been inactive, the control unit 314 will cause the doors of the vehicle to lock and the starter to become disabled.

An installed system is shown in FIG. 4, in which the invention is embedded in the on-board computer system 404 of the vehicle. In this embodiment, the computer system 404 already controls the door lock control system 406 so that only an additional data port 422 need be added to the computer system 404. The data port 422 is coupled to a multi-car removable receiver 412 while the vehicle is at the dealership. Once the vehicle is sold, the multi-car removable receiver 412 is unplugged from the data port 422.

The vehicle may also come with an attached vehicle receiver 402 that allows operation of a keyless entry system by the end user. Therefore, the computer system 404 must be programmed to recognize the difference between a keyless entry system activation code entered through the attached vehicle receiver 402 and a dealership code received by the multi-car removable receiver 412. The computer system 404 may also be programmed to deactivate the attached vehicle receiver 402 when the multi-car removable receiver 412 is in use.

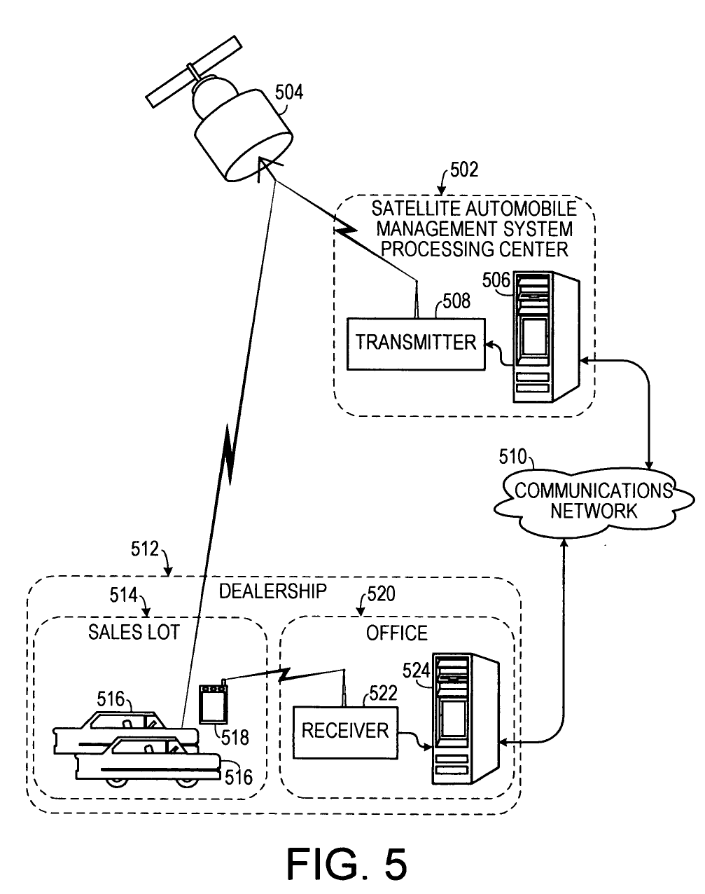

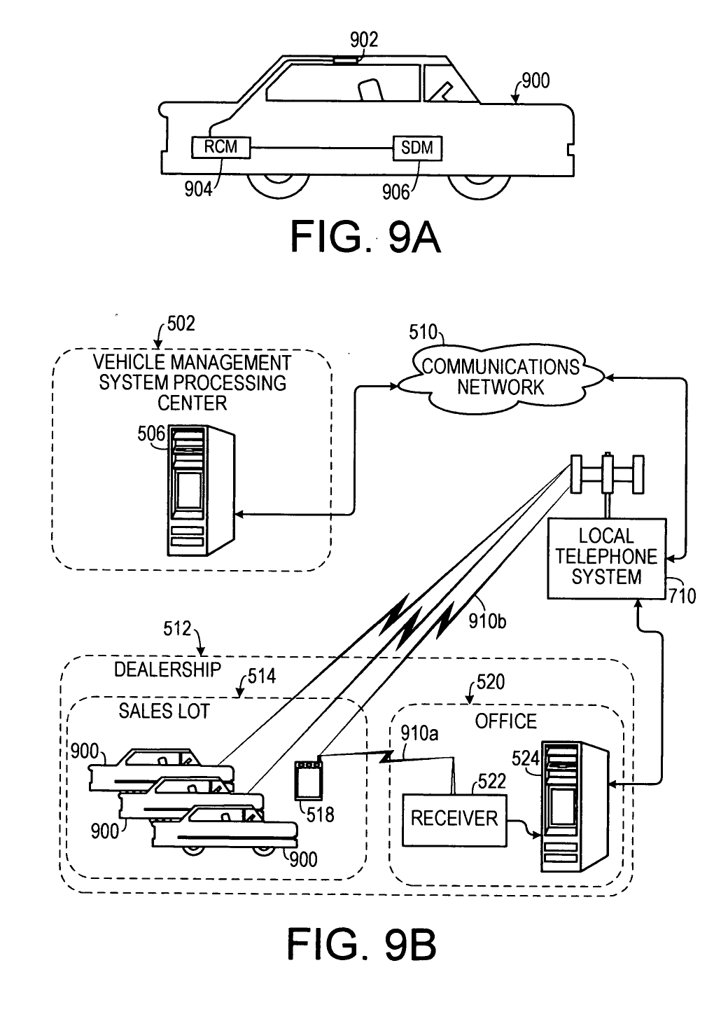

One embodiment of the invention, as shown in FIGS. 5-8, employs a satellite-based vehicle management system to lock or unlock the doors of the vehicles and to change other operating parameters of the vehicles, such as to enable or disable operation of the vehicle. The vehicle disable feature allows the keys to be left in the vehicle (such as in the glove compartment) without fear of someone breaking into the vehicle and driving off with it at night. Examples of an existing satellite-based vehicle management system includes and MILLENNIUM PLUS GPS, which is offered by Millennium Plus, LLC (which may be reached at: 2741 W Southern, Suite 6, Tempe, Ariz. 85282, Tel.: 866.213.5138, Email: contact@mplusgps.com). Another embodiment of the invention, as shown in FIGS. 9A and 9B, employs a wireless telephone system-based vehicle management system to control the vehicles. One example of a wireless telephone system-based vehicle management system includes On-Star®, which is currently offered by General Motors, Inc. (which may be reached at: OnStar Subscriber Services, P.O. Box 0217, Troy, Mich. 48099-0217, Tel.: 888-466-7827, www.onstar.com)

As shown in FIG. 5, one embodiment includes a base station 520 that includes a computer 524 that is in communication with a receiver 522 (or possibly a transceiver for two-way communication embodiments) located at a central location of the dealership 512. The vehicles 516 are located on the sales lot 514 and have installed therein a satellite-based vehicle control system (not shown), such as a factory-installed controller of the type available from On-Star® or an installable system of the type available from MILLENNIUM PLUS, LLC. Typically, each salesperson would be supplied with a wireless communication device 518 (e.g., a wireless-enabled PDA or a proprietary wireless device) that is in communication with the receiver 522. The computer 524 is in communication with a communications network 510 (which could be a global computer network, a telephone network or even a proprietary network).

The communications network 510 is in communication with a satellite-based vehicle management system 502, which includes a server 506 that is in communication with a transmitter 508 (which could be a transceiver for two-way communication embodiments). The transmitter 508 is in communication with a satellite 504 which is able to control each of the vehicles 516 through the vehicle's satellite-based vehicle control system.

When a salesperson desires to unlock and enable a selected vehicle, the salesperson enters a vehicle identifier (such as the vehicle's VIN number, or another vehicle identifying code used by the dealership) in the wireless communication device and sends an unlock instruction signal to the base station 520. The receiver 522 receives the instruction signal and communicates the instruction to the computer 524. After verifying that the salesperson is authorized to activate the vehicle 516, the computer 524 initiates a communication with the satellite-based vehicle management system 502 via the communications network 510. The computer is programmed to instruct the satellite-based vehicle management system 502 to change the vehicle's operating parameters to the desired operating states (in this case to unlock the doors and enable operation of the vehicle) using the protocol of the satellite-based vehicle management system 502.

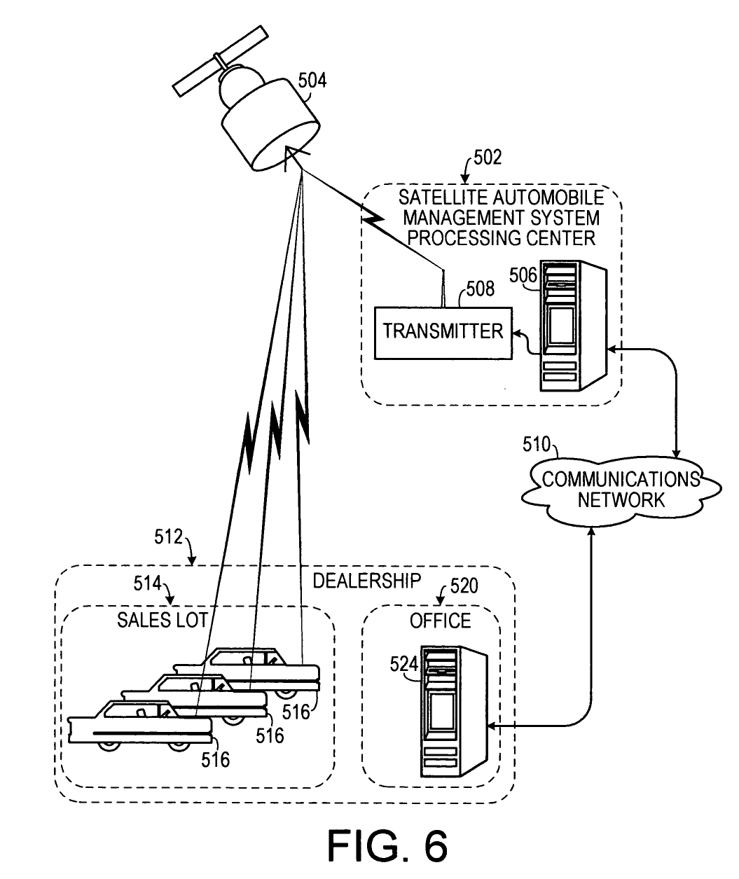

In one embodiment, as shown in FIG. 6. The dealership 512 does not need to use the wireless communication device 518, but only uses the computer 524 to unlock the doors and enable operation of a plurality of vehicles 516 on the sales lot 514 at a preselected time (e.g., when the dealership 512 opens in the morning) and to lock the doors and disable operation of a plurality of vehicles on the sales lot 514 at another preselected time (e.g., at the dealership's closing time). The computer 524 monitors the current time and then initiates an instruction to change the operating parameters of the vehicles 516 when a preselected time is reached. The computer 524 could also be programmed to monitor parameters other than time to change the vehicles' states upon the occurrence of other events. In this embodiment, a plurality of the vehicles 516 may have their operating states changed substantially simultaneously. In this embodiment, the salesperson on the sales lot 514 could use a radio or a cell phone to call an operator in the office 520 to request that a vehicle 516 be unlocked. The operator would then input an instruction to the computer to cause the vehicle 516 to be unlocked. This embodiment requires only a computer 524, but has the added overhead of also requiring an operator. However, if someone (such as a receptionist) is under-utilized, then assigning that person the ancillary duty of entering vehicle state change requests into the computer 524 might not decrease efficiency.

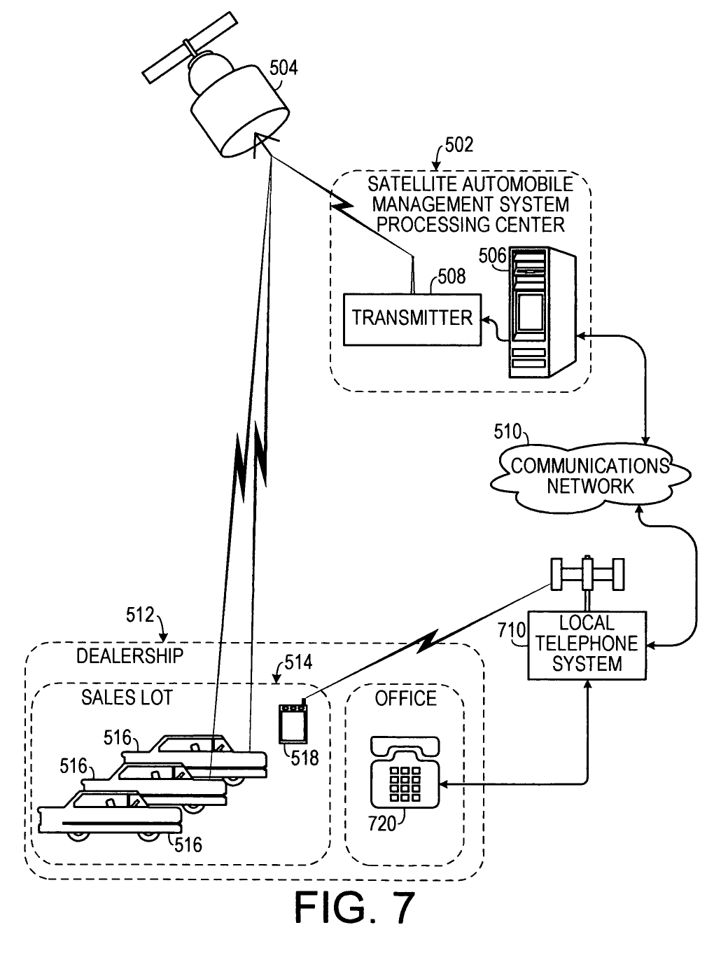

Another embodiment, as shown in FIG. 7, does away with the need for a base station. In this embodiment, the satellite-based vehicle management system 502 is programmed to receive instructions from the dealership. Such instructions could be made from the sales lot 514 using a wireless communications device 518 (such as a cell telephone or a wireless-capable PDA) or could be made from the central office of the dealership 512 using a conventional telephone 720. The communications are directed to a local telephone system 710, such as a cell system or a local exchange carrier. The instruction could include an instruction to change the operating parameter(s) of a single vehicle 516 or a plurality of vehicles 516 on the sales lot 514. The satellite-based vehicle management system 502 would be programmed to verify the communication and execute the instruction. The satellite-based vehicle management system 502 could also be pre-programmed to lock and disable all vehicles on a sales lot at a given time (or to execute some other instruction affecting the operating states of a plurality of vehicles upon the occurrence of a preselected event). In such a case, the dealer could effect changes in the satellite-based vehicle management system 502 program with respect to that dealership by entering a sequence of predefined telephone inputs.

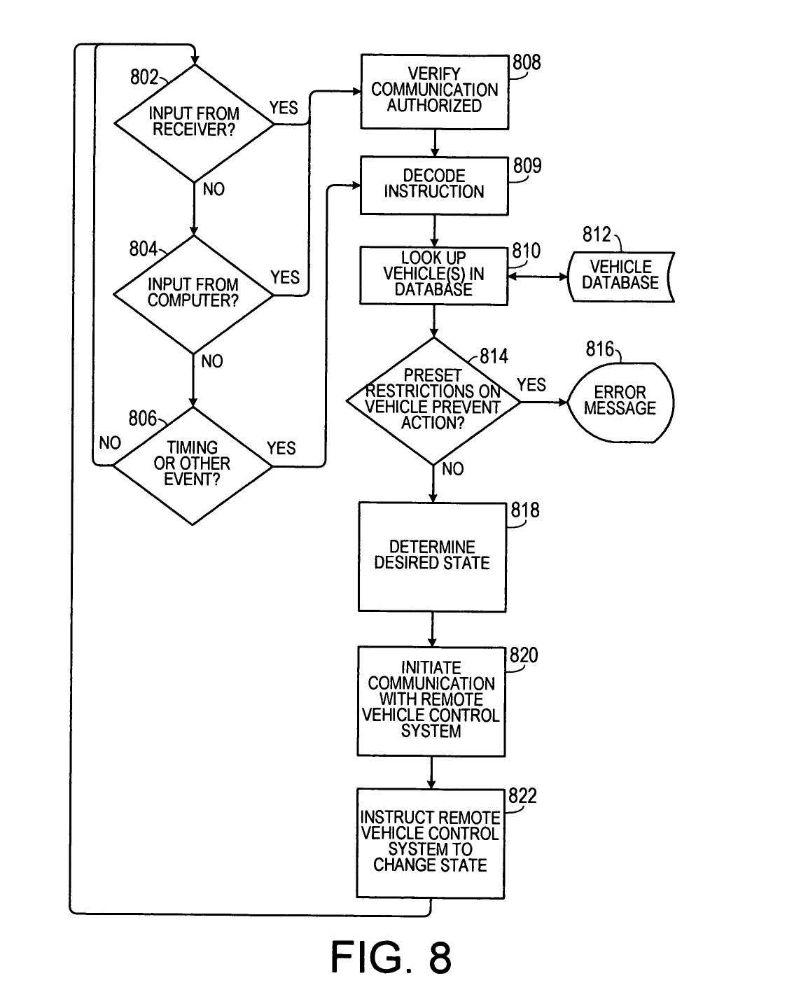

As shown in FIG. 8, one method of using the system disclosed above includes initially waiting for a triggering event, which could include an input received from the receiver 802 (such as when a salesperson initiates an operating parameter change request from a wireless device), an input from the computer 804 (such as when an operator initiates an operating parameter change request via a user interface) or the occurrence of a timing or other event 806 (examples include: a complete lock down at the dealership's scheduled closing time, or even a complete lock down when a severe weather notification is received).

Once an input is received, the system can verify 808 that the person making the input is authorized to make the requested parameter change. This step can include a user identification and password input request and a look-up of authorized user rights. Once the user has been allowed onto the system, the instruction from the user is looked up from a database and the corresponding instructions of the satellite-bases system protocol are retrieved 809. Also, the information about the selected vehicle necessary to execute the instruction are looked up 810 in a vehicle database 812. This step also verifies that the vehicle is still on the sales lot (so as not to anger customers of purchased vehicles, or potential customers who are on a test drive). The system determines if there are any preset restrictions of the vehicle that would prevent the requested action 814. This would prevent, for example, a dishonest employee from enabling use of a vehicle after the authorized hours for the vehicle, or prevent an employee who is not allowed to make sales of a certain brand or class of vehicle from activating a vehicle. If there is a restriction that would prevent use of the vehicle, an error message is displayed 816.

It may be necessary to determine the current state of the vehicle 818 to determine if any action is required from the satellite-based system. For example, it would be unnecessary to unlock a door that is already unlocked. The vehicle database 812 can track such states by associating state flags with a vehicle record.

Once the state change is authorized and all necessary vehicle data are collected, the computer initiates a communication 820 with a remote vehicle control system (such as a satellite-based system or a wireless telephone-based system ) and instructs 822 the remote vehicle control system to effect the desired state change. The remote vehicle control system then effects the state change using its protocol.

A typical vehicle 900, as shown in FIG. 9A, employing a wireless telephone system-based vehicle management system (such as OnStar®) includes a cellular antenna 902 that is in communication with a vehicle management system control module 904, which is in communication with a sensing and diagnostics module 906. The sensing and diagnostics module 906 receives input from the vehicle management system control module 904 and controls functions of such automatic devices as: the door locking/unlocking mechanism; the starter; the fuel pump and other devices that influence operation of the vehicle 900.

An embodiment employing a wireless telephone system-based vehicle management system is shown in FIG. 9B. In such a system, when a salesperson wishes to open a vehicle (or vehicles) 900, an identification of the vehicle 900 is entered into the wireless handheld device 518, which then initiates a communication 910a with a local base station 522 or initiates a communication 910b directly with a wireless telephone system 710 (depending on the embodiment employed). Either communication results in an instruction to unlock the vehicle being sent to the vehicle management system processing center 502. The vehicle management system processing center 502 sends an instruction to the local wireless telephone system 710 to contact the desired vehicle 900 causing the vehicle management system control module 904 to input a code into the sensing and diagnostics module 906 that causes the doors to be unlocked. This same system could also be used to lock the doors and to enable or disable the vehicle (by, for example, changing the state of the ignition or the fuel pump). The wireless handheld device 518 could be programmed with group codes that would allow a user to change the states of a predetermined group of vehicles on the sales lot 514, wherein entering one of the codes causes the vehicle management system processing center 502 change the state of the vehicles in the group sequentially.

In one embodiment, the wireless handheld device 518 could be programmed with the codes sent out by the vehicle management system processing center 502, which would allow direct control of the vehicles 900 by the wireless handheld device 518, without having to contact the vehicle management system processing center 502.

In yet another embodiment of the invention, the base station stores the keyless entry codes for a vehicle and then transmits the codes over a short-range transmitter (not shown), or regenerates them, when a request for door unlocking is received. Thus, the base station acts as a keyless entry device emulator. In this embodiment, the base station would also include a receiver that receives the codes from the vehicle's keyless entry device. In the case wherein the keyless entry device uses a pseudo-random number generator, the base station can be programmed to parallel the pseudo-random number generator for the vehicle, or it can read and store a plurality of locking/unlocking code transmission events from the vehicle's keyless entry device. This embodiment does not require additional hardware to be installed in the vehicle.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A station, used by an automobile dealership having a sales lot, for managing operating parameters of a plurality of vehicles that are responsive to a wireless telephone system-based vehicle management system, the station responsive to a wireless communications device used by a salesperson, the station comprising:
a. a receiver that receives transmissions from the wireless communications device; and
b. a computer, in communication with the receiver and in communication with a communications network, the computer programmed to execute the following instructions:
i. receive a communication from the wireless communications device indicating that the salesperson desires to change an operating parameter of a selected vehicle on the sales lot to a desired operating state;
ii. examine a database to retrieve a predetermined code corresponding to the selected vehicle; and
iii. send a communication via the communications network to the wireless telephone system-based vehicle management system, the communication instructing the wireless telephone system-based vehicle management system to send a signal via a wireless telephone system to the selected vehicle that will place the selected vehicle in the desired operating state.

2. The station of claim 1, wherein the desired operating state comprises a selected one of the doors of the vehicle being locked and the doors of the vehicle being unlocked.

3. The station of claim 1, wherein the desired operating state comprises a selected one of operation of the vehicle being enabled and operation of the vehicle being disabled.

4. The station of claim 1, wherein the computer is further programmed to execute the following instructions:
a associate a set of the plurality of vehicles with a predetermined event and a predefined operating parameter that the set of the plurality of vehicles is to be placed in upon occurrence of the predetermined event;
b. monitor a parameter to determine when the event occurs; and
c. upon detection of the occurrence of the predetermined event, send an instruction to the satellite-based vehicle management system to cause each of the set of the plurality of vehicles to be placed in the predefined operating parameter.

5. The station of claim 4, wherein the predetermined event comprises the reaching of a preselected time.

6. The station of claim 4, wherein the predetermined event comprises receiving user-initiated signal.

7. The station of claim 4, wherein the instruction comprises an instruction to lock the doors of each of the set of the plurality of vehicles.

8. The station of claim 4, wherein the instruction comprises an instruction to unlock the doors of each of the set of the plurality of vehicles.

9. The station of claim 4, wherein the instruction comprises an instruction to enable operation of each of the set of the plurality of vehicles.

10. The station of claim 4, wherein the instruction comprises an instruction to disable operation of each of the set of the plurality of vehicles.

11. A device for use in a vehicle dealership having a sales lot upon which are placed a plurality of vehicles, each of the plurality of vehicles being responsive to a wireless telephone system-based vehicle management system for controlling operating parameters of the plurality of vehicles, the device comprising a computer in communication with a communications network and programmed to execute the following steps:
a. associate a set of the plurality of vehicles with a predetermined event and a predefined operating parameter that the set of the plurality of vehicles is to be placed in upon occurrence of the predetermined event;
b. monitor a parameter to determine when the event occurs; and
c. upon detection of the occurrence of the predetermined event, send an instruction to the wireless telephone system-based vehicle management system to cause each of the set of the plurality of vehicles to be placed in the predefined operating parameter.

12. The device of claim 11, wherein the predetermined event comprises reaching a preselected time.

13. The device of claim 11, wherein the predetermined event comprises receiving a user-initiated signal.

14. The device of claim 11, wherein the instruction comprises an instruction to lock the doors of each of the set of the plurality of vehicles.

15. The device of claim 11, wherein the instruction comprises an instruction to unlock the doors of each of the set of the plurality of vehicles.

16. The device of claim 11, wherein the instruction comprises an instruction to enable operation of each of the set of the plurality of vehicles.

17. The device of claim 11, wherein the instruction comprises an instruction to disable operation of each of the set of the plurality of vehicles.

18. A method, programmed onto a digital computer in communication with a communications network, for managing a plurality of vehicles on a vehicle sales lot, wherein each of the vehicles is responsive to a wireless telephone system-based vehicle management system, comprising the steps of:
a. initiating a communication with the wireless telephone system-based vehicle management system; and
b. instructing the wireless telephone system-based vehicle management system to change an operating parameter of each of a plurality of vehicles on the sales lot substantially simultaneously.

19. The method of claim 18, further comprising the step of determining the occurrence of a preselected event and wherein the communication initiating step is executed upon the occurrence of the preselected event.

20. The method of claim 19, wherein the preselected event comprises reaching a preselected selected time and wherein the operating parameter change is selected from a list consisting essentially of: locking all of the doors of the set of the plurality of vehicles, unlocking all of the doors of the set of the plurality of vehicles, enabling operation of the set of the plurality of vehicles, and disabling operation of the set of the plurality of vehicles.

21. A method for managing a plurality of vehicles on a vehicle sales lot, each of the plurality of vehicles including circuitry such that at least one operating parameter of the vehicle is controllable by a wireless telephone system-based vehicle management system, comprising the steps of:
a. initiating a communication with a wireless telephone system-based vehicle management system; and
b. inputting a selected code to the wireless telephone system-based vehicle management system that instructs the wireless telephone system-based vehicle management system to change the operating parameter of each of the plurality of vehicles substantially simultaneously.
